(19) United States
(12) Patent Application Publication
(10) Pub. No.: US 2008/0148109 A1
(43) Pub. Date: Jun. 19, 2008

(54) IMPLICATING MULTIPLE POSSIBLE PROBLEMATIC COMPONENTS WITHIN A COMPUTER SYSTEM USING INDICATOR LIGHT DIAGNOSTICS

(76) Inventors: Paul D. Bashor, Cary, NC (US); Challis L. Purrington, Raleigh, NC (US); Terry L. Sawyers, Raleigh, NC (US); Mark W. Williams, Apex, NC (US)

Correspondence Address: HOFFMAN WARNICK & DALESSANDRO LLC, 75 STATE STREET, 14TH FLOOR, ALBANY, NY, 12207, US

(21) Appl. No.: 11/611,949

(22) Filed: Dec. 18, 2006

(51) Int. Cl. G06F 11/07

(52) U.S. Cl. 714/57; 714/E11.024

(57) ABSTRACT

A computer system is provided that utilizes a plurality of indicator lights associated with components within the computer system. In this computer system, BIOS logic is configured to detect errors within the system and determine causes for the errors. A service processor, in communication with the BIOS logic, is configured to activate at least two indicator lights from the plurality of indicator lights to indicate possible sources for the detected errors. The service processor activates the at least two indicator lights to generate a visual pattern representative of the likelihood that a component within the computer system is the source for the detected error. The visual pattern comprises a pattern that ranges from a pattern that indicates a high likelihood of being the source for the detected error to a pattern that indicates a lower likelihood of being the source for the detected error.

### BACKGROUND

This disclosure relates generally to identifying and locating a failed or failing system component within a computer system, and more specifically to using indicator lights with system components to indicate multiple possible sources for a failed or failing system component.

Some computer manufacturers have recently introduced computer systems that place fault identifying indicator lights such as light emitting diodes (LED) near system components that will light up when its associated component has failed or is failing. System components within these computer systems that may have their own fault identifying LED include components such as central processing units (CPUs), dual in-line memory modules (DIMMs), power supplies, fans, adaptor slots, and voltage regulators. As an example, if there is an error associated with a DIMM, then the fault identifying LED associated with the DIMM will light up to indicate that the DIMM has failed or is failing. A customer or service technician can then replace the faulty DIMM without having to troubleshoot whether the DIMM is responsible for the error. This allows the customer or service technician to quickly diagnose the source of the error, minimizing the amount of time that the computer is down because of the failed or failing system component.

An issue that arises with these computer systems that utilize fault identifying LEDs is that often times there may be more than one system component that is responsible for the error. For example, if there is an error associated with a DIMM, it is possible that the cause for error may be due to the memory controller which controls the flow of data to and from the DIMM, and not just due solely to the DIMM. Since replacing the DIMM is the most obvious solution, currently available light diagnostic approaches will only light the LED associated with the DIMM and not any LEDs associated with system components that may have a lesser probability of being the source of the DIMM error. If it turns out that the memory controller is responsible for the error, then the customer or service technician will have needlessly replaced a DIMM before realizing that the source of the error is the controller. Besides incurring unnecessary expenses, the customer or service technician will have wasted time trying to diagnose the error, which means more time that the computer system is down.

### SUMMARY

Because currently available computer systems that utilize fault identifying LEDs are unable to light up LEDs of multiple system components that may be possible sources for a detected error, computer manufacturers need to develop an approach that can activate LEDs of all system components that may be potentially responsible for an error, and provide an approach that can enable a customer or service technician to identify the likelihood that each of the lighted LEDs is the source of the error, in order to make a quick diagnosis and repair.

In one embodiment, there is a method for diagnosing faulty components within a computer system that utilizes indicator lights with components in the computer system to indicate possible failures. In this embodiment, the method comprises detecting an error within the computer system and determining at least two components within the computer system that are possible sources for the detected error. The method also comprises activating each of the indicator lights associated with the at least two components. In this method, each activated indicator light generates a visual pattern representative of the likelihood that a component is the source for the detected error. The visual pattern comprises a pattern that ranges from a pattern that indicates a high likelihood of being the source for the detected error to a pattern that indicates a lower likelihood of being the source for the detected error.

In another embodiment, there is a computer system that comprises a plurality of indicator lights associated with components within the computer system. BIOS logic is configured to detect errors within the computer system and determine causes for the errors. A service processor, in communication with the BIOS logic, is configured to activate at least two indicator lights from the plurality of indicator lights to indicate possible sources for the detected errors. The service processor activates the at least two indicator lights to generate a visual pattern representative of the likelihood that a component within the computer system is the source for the detected error. The visual pattern comprises a pattern that ranges from a pattern that indicates a high likelihood of being the source for the detected error to a pattern that indicates a lower likelihood of being the source for the detected error.

In a third embodiment, there is a computer-readable medium storing computer instructions for diagnosing faulty components within a computer system that utilizes indicator lights with components in the computer system to indicate possible failures. In this embodiment, the computer instructions comprises detecting an error within the computer system; determining at least two components within the computer system that are possible sources for the detected error; and activating each of the indicator lights associated with the at least two components, wherein each activated indicator light generates a visual pattern representative of the likelihood that a component is the source for the detected error, wherein the visual pattern comprises a pattern that ranges from a pattern that indicates a high likelihood of being the source for the detected error to a pattern that indicates a lower likelihood of being the source for the detected error, wherein the visual pattern comprises a steady on pattern, a fast blinking pattern and a slow blinking pattern, wherein the steady on pattern is indicative of a high likelihood that a component is the source for the detected error, the fast blinking pattern is indicative of a medium likelihood that a component is the source for the detected error and the slow blinking pattern is indicative of a lower likelihood that a component is the source for the detected error.

### BRIEF DESCRIPTION OF THE DRAWINGS

FIG. 1 shows a high-level schematic diagram of a computer system that indicates multiple possible sources for a failed or failing system component using fault identifying indicator lights; and

FIG. 2 is a flowchart describing some of the processing functions associated with using the system shown in FIG. 1 to diagnose faults utilizing the fault identifying indicator lights.

### DETAILED DESCRIPTION

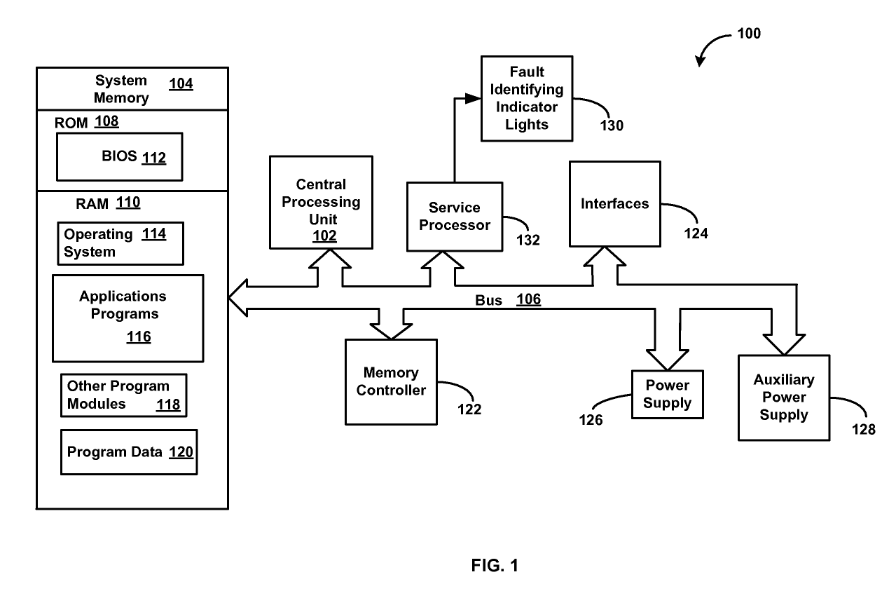

FIG. 1 shows a high-level schematic diagram of a computer system 100 that indicates multiple possible sources for a failed or failing system component using fault identifying indicator lights. The computer system 100 is suitable preferably for a computer server environment, however, the system is suitable in other general purpose or special purpose computing system environments or configurations. The computer system 100 only illustrates a limited number of system components to facilitate an understanding of the scope and content of this disclosure. The computer system 100 is not limited to these components shown in FIG. 1. Those skilled in the art will recognize that the computer system 100 may have more or less components than the ones illustrated in FIG. 1.

As shown in FIG. 1, the computer system 100 comprises one or more CPUs 102, a system memory 104, and a bus 106 that couples various system components to the CPU 102 and the system memory 104. The system memory 104 includes computer-readable media in the form of non-volatile memory, such as ROM 108 and/or volatile memory, such as random access memory (RAM) 110. A basic input/output system (BIOS) 112 stored in ROM 108 contains the basic routines that help initialize the computer system 100 and run diagnostics so that other software programs can load, execute, and assume control of the computer to transfer information between components within the system. RAM 110 typically contains data and/or program modules that are immediately accessible to and/or presently operated on by CPU 102. By way of example, and not limitation, the RAM 110 may include an operating system 114, one or more application programs 116, other program modules 118, and program data 120.

FIG. 1 also shows a memory controller 122 which manages the flow of data going to and from system memory 104. Other system components shown in FIG. 1 comprise interfaces 124 for interfacing with various peripheral devices that connect to the computer system 100. Although FIG. 1 only shows one component to represent the interfaces, those skilled in the art will recognize that the computer system may have several separate interfaces that facilitate communication with components and devices. FIG. 1 also shows a power supply 126 that supplies the energy to power the computer system 100 and an auxiliary power supply 128 that provides backup power to help support the operation of the computer system 100.

Each of the system components shown in FIG. 1 has a respective fault identifying indicator light 130 placed nearby. For ease of illustration, the fault identifying indicator lights are shown in FIG. 1 by one reference element 130. Typically, the planar or motherboard, where each of the various system components shown in FIG. 1 reside, will have a separate fault identifying indicator light beside the component. In one embodiment the fault identifying indicator lights 130 are an LED, however, those skilled in the art will recognize that other light indicating devices can be used.

In operation, the fault identifying indicator lights 130 will light up when its associated system component has failed or is failing for a predetermined duty cycle. Each of the fault identifying indicator lights 130 can generate a visual pattern that is representative of the likelihood that a component is the source for a noted error. For example, each fault identifying indicator light 130 can generate a visual pattern that comprises a full steady-on light that indicates that there is a high likelihood that the component is the source for the noted error. A fast blinking visual pattern may be indicative that there is a medium likelihood that the component is the source for the detected error. A slow blinking visual pattern may be indicative that there is a lower likelihood that a component is the source for the detected error.

These are only examples of some of the types of visual patterns that the fault identifying indicator lights 130 can generate and they are not meant to be limiting. Those skilled in the art will recognize that there are a multitude of other visual patterns that the fault identifying indicator lights 130 can generate. Furthermore, those skilled in the art will recognize that there are many other ways of correlating the likelihood that a visual pattern of a fault identifying indicator light is the cause of the error. In particular, terminology such as high, medium and lower likelihood are only illustrative of one way of correlating a visual pattern to the probability of being the cause of an error.

Referring back to FIG. 1, a service processor 132 will activate the fault identifying indicator lights 130 to generate the applicable visual pattern at a corresponding duty cycle. In particular, the service processor 132 is in communication with the BIOS 112, which will detect errors within the computer system 100 and determine causes for the errors. Typically, when the computer system 100 is powered on, the BIOS 112 obtains control of the system and performs a power-on self test (POST). If the logic of the BIOS detects errors during the POST it will then determine the possible causes for the error and notify the service processor 132 of the errors and instruct it to activate at least two fault identifying indicator lights 130 at a visual pattern and duty cycle that is indicative of the likelihood that the components are the source for the detected error. Other instances in which errors can be detected occur when the BIOS successfully performs the POST and passes control to the operating system. While the operating system has control, it is possible that hardware may detect errors. If so, the hardware calls the BIOS 112 which can isolate and identify potential sources for the detected error. In the manner described above, the BIOS 112 will then notify the service processor 132 of the errors and instruct it to activate at least two fault identifying indicator lights 130 at a suitable visual pattern and duty cycle that is indicative of the probability that the component is the source of the error.

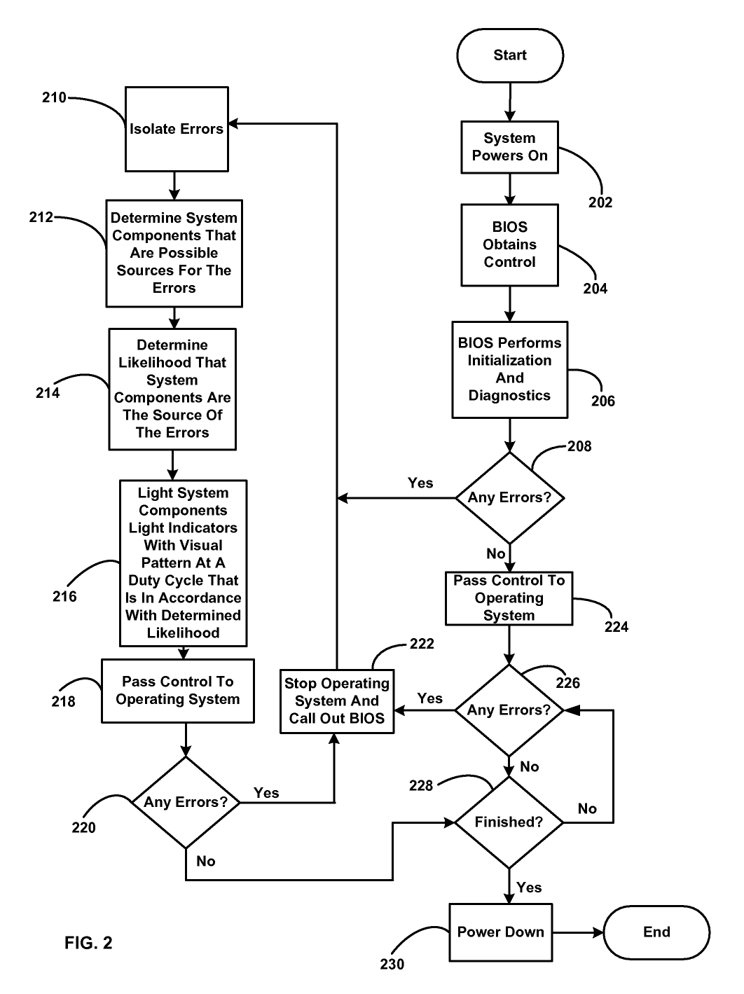

FIG. 2 is a flowchart 200 describing some of the processing functions associated with using the system 100 shown in FIG. 1 to diagnose faults utilizing the fault identifying indicator lights 130. The processing functions of FIG. 2 begin when the computer system powers on at 202. At 204, the BIOS gets control of the system and performs initialization and diagnostics (i.e., POST) at 206. If any errors are detected at 208, then the BIOS identifies and locates the errors at 210. In addition, the BIOS determines the system components that are possible sources for the errors at 212. In one embodiment, the BIOS will isolate at least two system components that are possible sources for the errors. Although the BIOS can isolate only one system component that is a possible source for the detected error, it is preferable that the BIOS determine at least two system components that are potential causes for the error, because as mentioned above, often the most likely cause for an error is not the most likely candidate and may be an overlooked.

After determining system components that are possible sources for the detected error, the BIOS determines the likelihood or probability that each system component is the source of the error at 214. Depending on the likelihood that a system component is the source of the error, the BIOS will then instruct the service processor to activate the fault identifying indicator lights associated with the isolated system components, causing the lights to generate a visual pattern that corresponds with the likelihood that the component is the source of the detected error at 216. As mentioned above, in one embodiment, a visual pattern that comprises a full steady-on light is indicative of a high likelihood that the component is the source for the detected error, a fast blinking visual pattern is indicative of a medium likelihood that the component is the source for the detected error, while a slow blinking pattern visual pattern is indicative of a lower likelihood that a component is the source for the detected error.

In addition to lighting the fault identifying indicator lights, the computer system will activate a warning light on the outside of the system to notify the user of an error. A user or service technician can then power-down the system and isolate the cause for the detected error. The user or service technician will then open the system to see what fault identifying indicator lights are illuminated and what visual pattern is being generated from each indicator. Note that even though the computer system has been powered-down, the auxiliary power source 128 is used to provide power to illuminate each of the relevant fault identifying indicator lights so that they can generate its selected visual pattern at a predetermined duty cycle.

Referring back to FIG. 2, after the service processor has activated the relevant fault identifying indicator lights, the BIOS passes control to the operating system at 218. If the computer system hardware determines an error while the operating system is running at 220, then the operating system will stop and call out the BIOS at 222. Process acts 210-220 are repeated until it is determined at 228 that the user is finished and ready to power down the computer system at 230.

If it is determined at processing block 208 that BIOS logic has not found any errors, then control is passed to the operating system at 224. If the computer system hardware determines an error while the operating system is running at 226, then the operating system will stop and call out the BIOS at 222 and proceed to perform process acts 210-220 until it is determined at 228 that the user is finished and ready to power down the computer system at 230.

The foregoing flow chart of FIG. 2 shows some of the processing functions associated with using the computer system 100 shown in FIG. 1 to diagnose faults utilizing fault identifying indicator lights 130. In this regard, each block in the flow chart represents a process act associated with performing these functions. It should also be noted that in some alternative implementations, the acts noted in the blocks may occur out of the order noted in the figure or, for example, may in fact be executed substantially concurrently or in the reverse order, depending upon the act involved. Also, one of ordinary skill in the art will recognize that additional blocks that describe these processing acts may be added.

It is apparent that there has been provided with this disclosure, an approach for implicating multiple possible problematic components within a computer system using indicator light diagnostics. While the disclosure has been particularly shown and described in conjunction with a preferred embodiment thereof, it will be appreciated that variations and modifications can be effected by a person of ordinary skill in the art without departing from the scope of the disclosure.

What is claimed is:

1. A method for diagnosing faulty components within a computer system that utilizes indicator lights with components in the computer system to indicate possible failures, the method comprising:
detecting an error within the computer system;
determining at least two components within the computer system that are possible sources for the detected error; and
activating each of the indicator lights associated with the at least two components, wherein each activated indicator light generates a visual pattern representative of the likelihood that a component is the source for the detected error, wherein the visual pattern comprises a pattern that ranges from a pattern that indicates a high likelihood of being the source for the detected error to a pattern that indicates a lower likelihood of being the source for the detected error.

2. The method according to claim 1, further comprising using a predetermined duty cycle for each of the indicator lights during the activation, wherein each predetermined duty cycle is representative of the likelihood that a component is the source for the detected error, wherein the predetermined duty cycle ranges from a duty cycle that indicates a high likelihood of being the source for the detected error to a duty cycle that indicates a lower likelihood of being the source for the detected error.

3. The method according to claim 1, wherein the visual pattern comprises a steady on pattern, a fast blinking pattern and a slow blinking pattern, wherein the steady on pattern is indicative of a high likelihood that a component is the source for the detected error, the fast blinking pattern is indicative of a medium likelihood that a component is the source for the detected error and the slow blinking pattern is indicative of a lower likelihood that a component is the source for the detected error.

4. The method according to claim 1, wherein the activating of indicator lights occurs while the computer system is powered down

5. A computer system, comprising:
a plurality of indicator lights associated with components within the computer system;
BIOS logic configured to detect errors within the computer system and determine causes for the errors; and
a service processor, in communication with the BIOS logic, configured to activate at least two indicator lights from the plurality of indicator lights to indicate possible sources for the detected errors, wherein the service processor activates the at least two indicator lights to generate a visual pattern representative of the likelihood that a component within the computer system is the source for the detected error, wherein the visual pattern comprises a pattern that ranges from a pattern that indicates a high likelihood of being the source for the detected error to a pattern that indicates a lower likelihood of being the source for the detected error.

6. The system according to claim 5, wherein the service processor activates the at least two indicator lights with a predetermined duty cycle, wherein each predetermined duty cycle is representative of the likelihood that a component is the source for the detected error, wherein the predetermined duty cycle ranges from a duty cycle that indicates a high likelihood of being the source for the detected error to a duty cycle that indicates a lower likelihood of being the source for the detected error.

7. The system according to claim 5, wherein the visual pattern comprises a steady on pattern, a fast blinking pattern and a slow blinking pattern, wherein the steady on pattern is indicative of a high likelihood that a component is the source for the detected error, the fast blinking pattern is indicative of a medium likelihood that a component is the source for the detected error and the slow blinking pattern is indicative of a lower likelihood that a component is the source for the detected error.

8. The system according to claim 5, further comprising an auxiliary power source that is configured to provide power to the service processor to activate the at least two indicator lights.

9. A computer-readable medium storing computer instructions for diagnosing faulty components within a computer system that utilizes indicator lights with components in the computer system to indicate possible failures, the computer instructions comprising:
detecting an error within the computer system;
determining at least two components within the computer system that are possible sources for the detected error; and
activating each of the indicator lights associated with the at least two components, wherein each activated indicator light generates a visual pattern representative of the likelihood that a component is the source for the detected error, wherein the visual pattern comprises a pattern that ranges from a pattern that indicates a high likelihood of being the source for the detected error to a pattern that indicates a lower likelihood of being the source for the detected error, wherein the visual pattern comprises a steady on pattern, a fast blinking pattern and a slow blinking pattern, wherein the steady on pattern is indicative of a high likelihood that a component is the source for the detected error, the fast blinking pattern is indicative of a medium likelihood that a component is the source for the detected error and the slow blinking pattern is indicative of a lower likelihood that a component is the source for the detected error.
